(19) United States
(12) Patent Application Publication
(10) Pub. No.: US 2018/0157625 A1
(43) Pub. Date: Jun. 7, 2018

(54) METHOD, SYSTEM AND APPARATUS FOR DISPLAYING AN ELECTRONIC DOCUMENT

(71) Applicant: CANON KABUSHIKI KAISHA, Tokyo (JP)

(72) Inventor: Albert Chang, Lindfield (AU)

(21) Appl. No.: 15/817,860

(22) Filed: Nov. 20, 2017

(30) Foreign Application Priority Data
Dec. 2, 2016 (AU) 2016266083

(51) Int. Cl. G06F 17/21

(52) U.S. Cl. CPC G06F 17/214; H04L 67/06; G06F 17/212

(57) ABSTRACT

A method of displaying an electronic document. A list of glyphs in an electronic document specified with a font is determined, the electronic document being received from a server. The method determines that a font file defining the font has been partially received by comparing a received portion of the font file with the list of glyphs, the font file having the list of glyphs stored in a first portion thereof, a first plurality of the glyphs of the font being arranged at a start of the font file and remaining glyphs of the font being stored in a remaining portion of the font file arranged after the first portion of the font file. A portion of the electronic document is rendered with the first portion of the font file concurrently with receiving the remaining portion of the font file. The rendered portion of the electronic document is displayed.

### REFERENCE TO RELATED APPLICATIONS

This application claims the benefit of priority under 35 U.S.C. § 119 of the filing date of Australian Patent Application No. 2016266083, filed 2 Dec. 2016, hereby incorporated by reference in its entirety as if fully set forth herein.

### TECHNICAL FIELD

The present invention relates to computer fonts and, in particular, to the delivery of fonts over a computer network and display of fonts that are transferred over network devices. The present invention also relates to a method and apparatus for displaying an electronic document, and to a computer program product including a computer readable medium having recorded thereon a computer program for displaying an electronic document.

### BACKGROUND

Electronic documents, which are served across a network, may reference resources that are also served across a network, in order to enable a rendering to be produced with an appearance that is predictable and appears exactly as the author intends. The referenced resources may be referred to as “network resources”. Such referenced resources may include images for displaying graphic content and fonts for display text content.

When an electronic document is served across a network without using network resources, there is often an assumption made that a client device displaying the electronic document stores the required resources locally. This assumption is often not satisfied due to the multitude of configurations of client devices that are possible. For example, a client device may not have fonts pre-loaded for certain languages such as Japanese and Chinese. Additionally, specific fonts that are pre-loaded on the client device may have a graphical style that does not align with the design intent of the author, necessitating the author to provide the resources when the electronic document is served to the client.

However, due to the large number of glyphs that are required to support some languages, such as Japanese and Chinese, serving font resources for these languages often consumes network bandwidth, as the font resources may be several megabytes in size. The performance for displaying the page is therefore affected due to a delay incurred in transmitting the font resources to the client device. Electronic documents relying on fonts provided across a network often incur a delay to display the page as the client waits to receive the font resource before successful display. Often all the required font resources are transferred over the network only when the resource files are available the electronic document is displayed. Transferring the required font resources over the network only when the resource files are available often introduces a blank page before display that can last for many seconds, thereby impacting on usability and conveying a sense of slowness.

One method of reducing the delay of initial document display is to render each item of content when the required resource is available, (i.e. before receiving all resources required for the document). Rendering each item of content before receiving all resources required for the document may cause the page display to update in many stages, resulting in partial content being shown as the document resources are loaded. While some content may be shown to the user in this instance, utilising large font files results in readable content to be displayed last impacting usability as the page cannot be read if font resources are not available. The above method does not reduce overall time to display the complete electronic document.

Another method of reducing the delay of initial document display is to use a local font as a temporary substitute and then use an intended font file once font resources have been completely loaded from a network. However, switching font files may result in a change of text style which can be jarring to the user, and may cause reading difficulties if the user has started reading before intended font is loaded. The switching font process may also cause text re-flow to occur, as the intended font may have different sizes/metrics, causing the user to lose track of reading location.

Another method of reducing delay of initial document display is to produce sparse fonts, which are fonts that include definitions only for the characters listed in the document. However, such sparse font methods do not support rendering of additional characters that are not used in the original document. Rendering of additional characters is important for documents with user-input forms which render input strings provided by the user or display of text from third-party sources that may be retrieved using methods such as RSS or XHR, REST, etc. As such, rendering of further pages and user input characters is likely to be delayed or be inconsistent with intent of the author of the document.

Thus, there is a need to enable font resources to be served over the network, with reduced delay in rendering of initial view of documents, while allowing correct rendering of further pages and additional text content.

### SUMMARY

It is an object of the present invention to substantially overcome, or at least ameliorate, one or more disadvantages of existing arrangements.

According to one aspect of the present disclosure, there is provided a method of displaying an electronic document, the method including determining a list of glyphs in an electronic document specified with a font, the electronic document being received from a server; determining that a font file defining the font has been at least partially received by comparing a received portion of the font file with the determined list of glyphs, the font file having the determined list of glyphs stored in a first portion of the font file, a first plurality of the glyphs of the font being arranged at a start of the font file and remaining glyphs of the font being stored in a remaining portion of the font file arranged after the first portion of the font file; rendering a portion of the electronic document with the first portion of the font file concurrently with receiving the remaining portion of the font file; and displaying the rendered portion of the electronic document.

According to another aspect of the present disclosure, there is provided an apparatus for displaying an electronic document, the apparatus including means for determining a list of glyphs in an electronic document specified with a font, the electronic document being received from a server; means for determining that a font file defining the font has been at least partially received by comparing a received portion of the font file with the determined list of glyphs, the font file having the determined list of glyphs stored in a first portion of the font file, a first plurality of the glyphs of the font being arranged at a start of the font file and remaining glyphs of the font being stored in a remaining portion of the font file arranged after the first portion of the font file; means for rendering a portion of the electronic document with the first portion of the font file concurrently with receiving the remaining portion of the font file; and means for displaying the rendered portion of the electronic document.

According to still another aspect of the present disclosure, there is provided a system for displaying an electronic document, the system including a memory for storing data and a computer program; a processor coupled to the memory for executing the computer program, the computer program comprising instructions for: determining a list of glyphs in an electronic document specified with a font, the electronic document being received from a server; determining that a font file defining the font has been at least partially received by comparing a received portion of the font file with the determined list of glyphs, the font file having the determined list of glyphs stored in a first portion of the font file, a first plurality of the glyphs of the font being arranged at a start of the font file and remaining glyphs of the font being stored in a remaining portion of the font file arranged after the first portion of the font file; rendering a portion of the electronic document with the first portion of the font file concurrently with receiving the remaining portion of the font file; and displaying the rendered portion of the electronic document.

According to still another aspect of the present disclosure, there is provided a non-transitory computer readable medium having a computer program stored thereon for displaying an electronic document, the program including code for determining a list of glyphs in an electronic document specified with a font, the electronic document being received from a server; code for determining that a font file defining the font has been at least partially received by comparing a received portion of the font file with the determined list of glyphs, the font file having the determined list of glyphs stored in a first portion of the font file, a first plurality of the glyphs of the font being arranged at a start of the font file and remaining glyphs of the font being stored in a remaining portion of the font file arranged after the first portion of the font file; code for rendering a portion of the electronic document with the first portion of the font file concurrently with receiving the remaining portion of the font file; and code for displaying the rendered portion of the electronic document.

Other aspects of the invention are also disclosed.

### BRIEF DESCRIPTION OF THE DRAWINGS

One or more embodiments of the invention will now be described with reference to the following drawings, in which:

FIGS. 1A and 1B collectively form a schematic block diagram of a general purpose computer with which the described arrangements may be practised;

FIG. 2 is a schematic flow diagram showing a method of displaying an electronic document referencing a network transferred font;

FIG. 3 is a schematic flow diagram showing another method of rendering an electronic document referencing a network transferred font with further additional updates to the document;

FIG. 4 is a schematic flow diagram showing a method of rendering a visible portion of a document, as used in the method of FIG. 3;

FIG. 5 is a schematic flow diagram showing a method of transferring a font file over the network with support for notifications to allow processing of the font file before the entire font file is completely transferred, as used in the method of FIG. 3;

FIG. 6A and FIG. 6B collectively show different viewports requiring different initial display content when the document is initially displayed;

FIG. 7 is a schematic flow diagram showing a method of modifying a font file to place characters according to order of appearance within the document at the front of the font file;

FIG. 8 is a diagram showing the typical layout of a typical font file;

FIG. 9 is a diagram showing an example font file which includes some Latin characters;

FIG. 10 is a diagram showing an example font file which includes some Latin characters and an example Japanese Kanji character;

FIG. 11 is a diagram showing a form of the example font file shown in FIG. 10, after the font file has been processed in accordance with the method of FIG. 7;

FIG. 12A is a diagram showing sections of sections of an un-optimised font file storing location of data used for displaying an initial viewable portion of a document;

FIG. 12B is a diagram showing sections of an optimised font file storing location of data used for displaying the initial viewable portion of a document; and

FIG. 13 is a schematic flow diagram showing another method of rendering an electronic document referencing a network transferred font.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

Electronic documents may be defined using a markup language such as the HyperText Markup Language (HTML) as defined by the organisation World Wide Web Consortium (W3C). Displayable text content in such documents is stored as strings of glyph characters each given by a specific Unicode code-point. Fonts that are referenced by such electronic documents, also known as Web Fonts, can be in a standard format such as TrueType, OpenType or WOFF (Web Open Font Format). These font standards allow access to glyphs through index values that are determined by lookup in a character map table (embedded within the font file) in order to determine the index for a specified Unicode code-point.

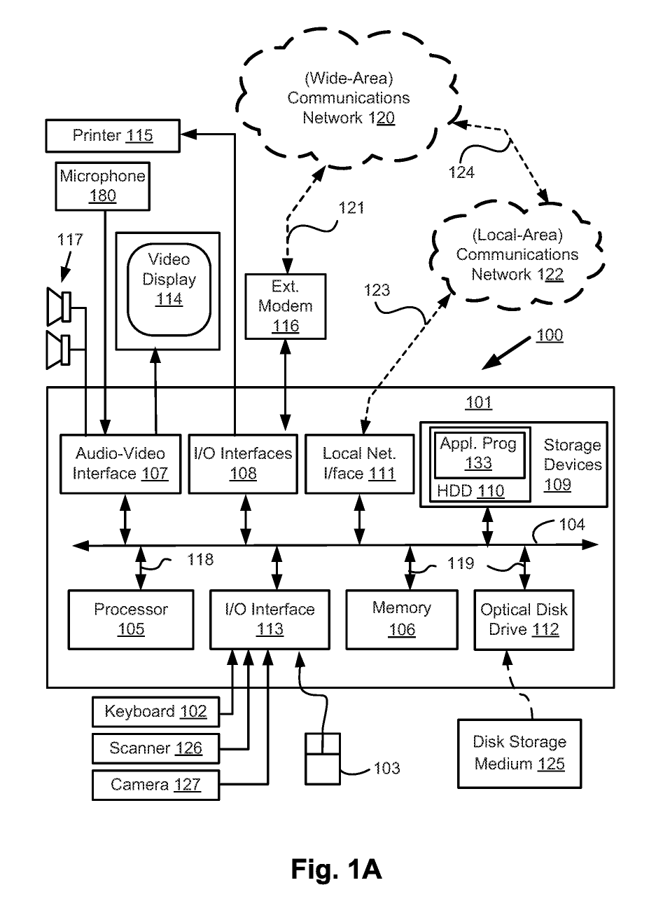

FIGS. 1A and 1B depict a general-purpose computer system 100, upon which the various arrangements described below may be practiced.

As seen in FIG. 1A, the computer system 100 includes: a computer module 101; input devices such as a keyboard 102, a mouse pointer device 103, a scanner 126, a camera 127, and a microphone 180; and output devices including a printer 115, a display device 114 and loudspeakers 117. An external Modulator-Demodulator (Modem) transceiver device 116 may be used by the computer module 101 for communicating to and from a communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

The computer module 101 typically includes at least one processor unit 105, and a memory unit 106. For example, the memory unit 106 may have semiconductor random access memory (RAM) and semiconductor read only memory (ROM). The computer module 101 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, camera 127 and optionally a joystick or other human interface device (not illustrated); and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1A, the local communications network 122 may also couple to the wide network 120 via a connection 124, which would typically include a so-called “firewall” device or device of similar functionality. The local network interface 111 may comprise an Ethernet circuit card, a Bluetooth® wireless arrangement or an IEEE 802.11 wireless arrangement; however, numerous other types of interfaces may be practiced for the interface 111.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PC's and compatibles, Sun Sparcstations, Apple Mac™ or a like computer systems.

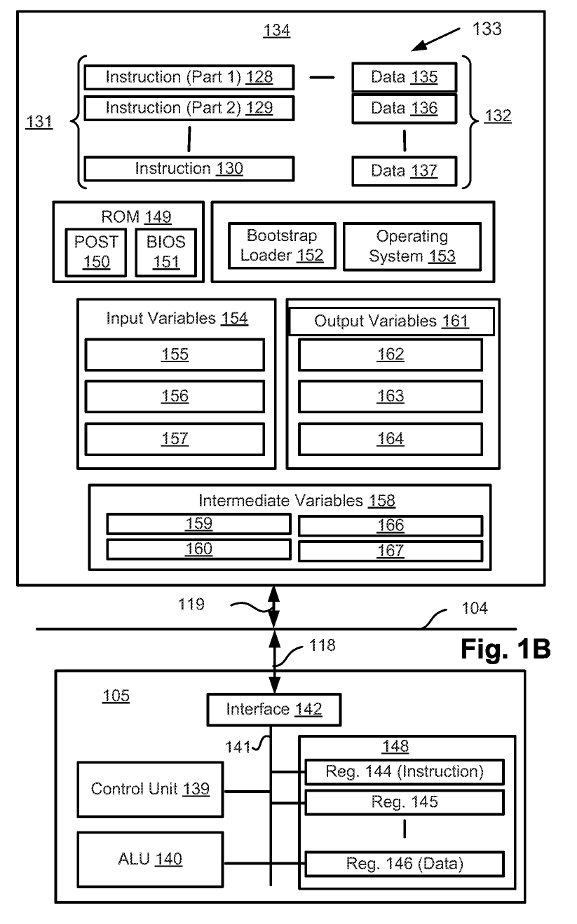

Methods described below may be implemented using the computer system 100 wherein the processes of FIGS. 2 to 12B, to be described, may be implemented as one or more software application programs 133 executable within the computer system 100. In particular, the steps of the described methods may be effected by instructions 131 (see FIG. 1B) in the software 133 that are carried out within the computer system 100. The software instructions 131 may be formed as one or more code modules, each for performing one or more particular tasks. The software may also be divided into two separate parts, in which a first part and the corresponding code modules performs the one or more of the described methods and a second part and the corresponding code modules manage a user interface between the first part and the user.

The software may be stored in a computer readable medium, including the storage devices described below, for example. The software 133 is typically stored in the HDD 110 or the memory 106. The software is loaded into the computer system 100 from the computer readable medium, and then executed by the computer system 100. Thus, for example, the software 133 may be stored on an optically readable disk storage medium (e.g., CD-ROM) 125 that is read by the optical disk drive 112. A computer readable medium having such software or computer program recorded on the computer readable medium is a computer program product. The use of the computer program product in the computer system 100 preferably effects an advantageous apparatus for implementing the described methods.

In some instances, the application programs 133 may be supplied to the user encoded on one or more CD-ROMs 125 and read via the corresponding drive 112, or alternatively may be read by the user from the networks 120 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the application programs 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 1B is a detailed schematic block diagram of the processor 105 and a “memory” 134. The memory 134 represents a logical aggregation of all the memory modules (including the HDD 109 and semiconductor memory 106) that can be accessed by the computer module 101 in FIG. 1A.

When the computer module 101 is initially powered up, a power-on self-test (POST) program 150 executes. The POST program 150 is typically stored in a ROM 149 of the semiconductor memory 106 of FIG. 1A. A hardware device such as the ROM 149 storing software is sometimes referred to as firmware. The POST program 150 examines hardware within the computer module 101 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1A. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high level functions, including processor management, memory management, device management, storage management, software application interface, and generic user interface.

The operating system 153 manages the memory 134 (109, 106) to ensure that each process or application running on the computer module 101 has sufficient memory in which to execute without colliding with memory allocated to another process. Furthermore, the different types of memory available in the system 100 of FIG. 1A must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

As shown in FIG. 1B, the processor 105 includes a number of functional modules including a control unit 139, an arithmetic logic unit (ALU) 140, and a local or internal memory 148, sometimes called a cache memory. The cache memory 148 typically includes a number of storage registers 144 - 146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The application program 133 includes a sequence of instructions 131 that may include conditional branch and loop instructions. The program 133 may also include data 132 which is used in execution of the program 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 1105 waits for a subsequent input, to which the processor 105 reacts to by executing another set of instructions. Each input may be provided from one or more of a number of sources, including data generated by one or more of the input devices 102, 103, data received from an external source across one of the networks 120, 102, data retrieved from one of the storage devices 106, 109 or data retrieved from a storage medium 125 inserted into the corresponding reader 112, all depicted in FIG. 1A. The execution of a set of the instructions may in some cases result in output of data. Execution may also involve storing data or variables to the memory 134.

The disclosed arrangements use input variables 154, which are stored in the memory 134 in corresponding memory locations 155, 156, 157. The disclosed arrangements produce output variables 161, which are stored in the memory 134 in corresponding memory locations 162, 163, 164. Intermediate variables 158 may be stored in memory locations 159, 160, 166 and 167.

Referring to the processor 105 of FIG. 1B, the registers 144, 145, 146, the arithmetic logic unit (ALU) 140, and the control unit 139 work together to perform sequences of micro-operations needed to perform “fetch, decode, and execute” cycles for every instruction in the instruction set making up the program 133. Each fetch, decode, and execute cycle comprises:
a fetch operation, which fetches or reads an instruction 131 from a memory location 128, 129, 130;
a decode operation in which the control unit 139 determines which instruction has been fetched; and
an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

Each step or sub-process in the processes of FIGS. 2 to 12A is associated with one or more segments of the program 133 and is performed by the register section 144, 145, 147, the ALU 140, and the control unit 139 in the processor 105 working together to perform the fetch, decode, and execute cycles for every instruction in the instruction set for the noted segments of the program 133.

The described methods may alternatively be implemented in dedicated hardware such as one or more integrated circuits performing the functions or sub functions of the described methods. Such dedicated hardware may include graphic processors, digital signal processors, or one or more microprocessors and associated memories.

FIG. 2 is a schematic flow diagram showing a method 200 of displaying an electronic document referencing a network transferred font with reduced delay in page display, in accordance with the present disclosure. The electronic document may be received from a server connected, for example, to the network 120. The method 200 may be implemented as one or more software code modules of the software application program 133 resident on the hard disk drive 110 and being controlled in its execution by the processor 105.

The method 200 commences at list determining step 201, where a list of glyphs in the document specified with a font is determined under execution of the processor 105. The determined list of glyphs and font of the document may be stored in the memory 106.

Continuing onto visible portion determining step 202, where the visible portion of the document is determined under execution of the processor 105.

Then at portion determining step 203, a first portion of the font file containing glyphs from the list of glyphs first determined at step 201 is transferred over the network 120. The font file has the determined list of glyphs stored in the first portion of the font file. A first plurality of the glyphs of the font are arranged at a start of the font file and remaining glyphs of the font are stored in a remaining portion of the font file arranged after the first portion of the font file. The first plurality of glyphs is referenced by an initial view of the document. The glyphs in the first portion are ordered according to an order of appearance of the glyphs in the document.

Also at step 202, a determination that the font file defining the font has been at least partially received may be performed, under execution of the processor 105, by comparing a received portion of the font file with the determined list of glyphs.

Continuing onto rendering step 204, the visible portion of the document, being an initial view of the document and containing only glyphs included in the first portion of the font file, is rendered using the first portion of the font file. The visible portion of the document uses a subset of the glyphs in the list of glyphs determined at step 201. The portion of the document rendered at step 204 is a visible portion of the document which may be displayed to a user as described below.

Then at displaying step 205, the rendered visible portion determined at step 205 is displayed to the user (e.g., on the display 114), to make the initial view of the document visible to the user. The flow diagram then ends following step 205. Remaining glyphs defined for the font, not included in the first portion of the font file, and not displayed in the initial view of the document, continue to be transferred. The visible portion determined at step 205 is rendered at step 204 concurrently with receiving the remaining portion of the font file containing the remaining glyphs. The remaining glyphs are utilised when displaying further document pages and/or updates to the page content, for example, in response to user input or rendering dynamic content. As an example, a glyph of the remaining portion of the font file may be used to render user input to the electronic document. As another example, the font file may be cached on the client device so that the font file, i.e. the first portion of the font file and the remaining portion of the font file, is available for rendering glyphs in a second electronic document. As such, the font file may be used for rendering glyphs in a second electronic document.

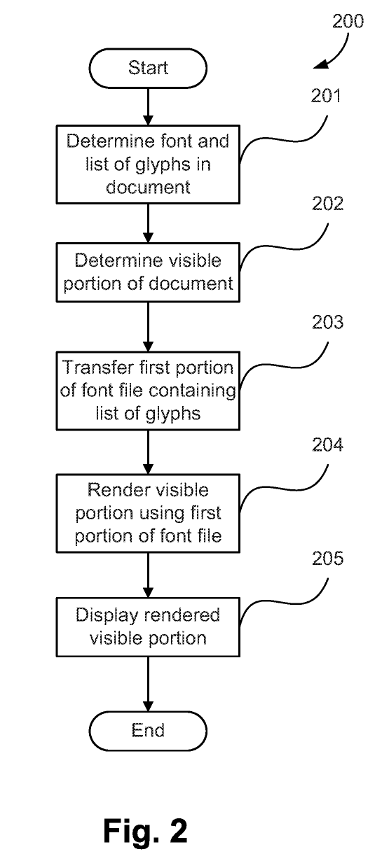

FIG. 3 is a schematic flow diagram showing a method 300 of rendering an electronic document referencing a network transferred font with reduced delay in page display, in accordance with the present disclosure. According to the steps of FIG. 3, handling of any additional modifications to the pages using additional glyphs not referenced in the original document is also performed with reduced delay.

The method 300 may be implemented as one or more software code modules of the software application program 133 resident on the hard disk drive 110 and being controlled in its execution by the processor 105.

The method 300 begins at list determining step 301, where the fonts and list of glyphs used in the document are determined under execution of the processor 105. The list may be stored in the memory 106 for example. Following from step 301, concurrent steps are initiated at step 302.

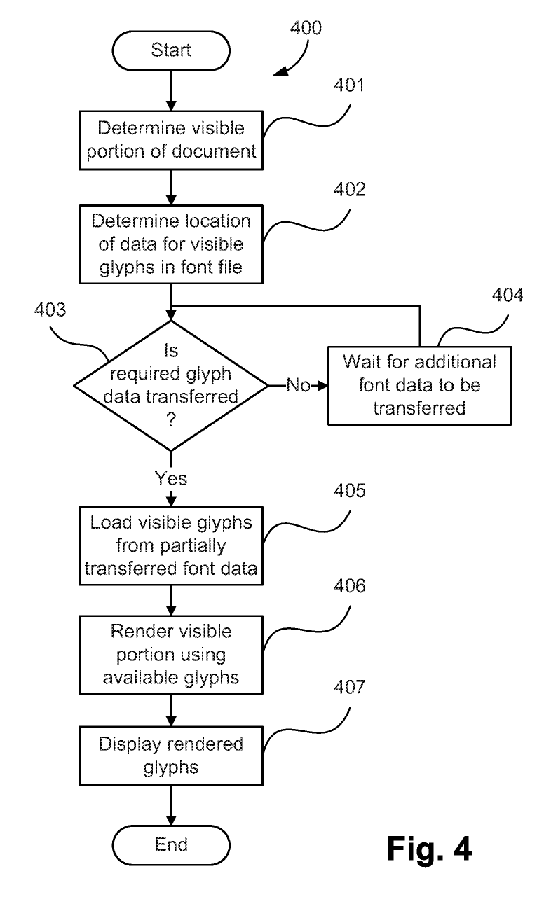

Continuing from step 302, the first concurrent step is transferring step 303, where the font files are transferred under execution of the processor 105. A method 500 of transferring font files over the network 120, as executed at step 303, will be described in detail below with reference to FIG. 5.

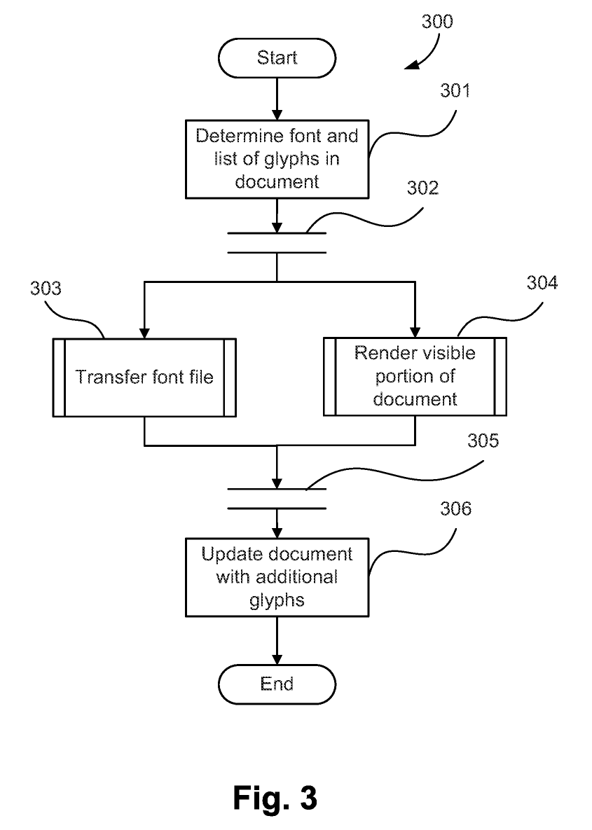

Also continuing from step 302, occurring concurrently with step 303, is rendering step 304, where a visible portion of the document is rendered under execution of the processor 105. Given that the font file is configured to have all glyphs of the document at the beginning of the font file (i.e. in a first portion of the font file), step 304 can proceed as soon as the first portion of the font file has been transferred in the concurrent step 303 without affecting user experience. As such, during step 304 for rendering the visible portion of the document, the font file continues to be transferred. A method 400 of rendering the visible portion of the document, as executed at step 304, will be described in detail below with reference to FIG. 4. Once the step 304 of rendering the visible portion of the document is completed, an initial rendering of the document is displayed (e.g., on the display 314) with reduced delay. Once the steps from 303 and 304 are completed, the method continues to updating step 306, where further updates are performed on the document under execution of the processor 105. The document is updated using definitions for additional glyphs not included in the first portion for rendering and updating the display of the document. The method 300 terminates following step 306.

The method 300 utilises concurrency for steps 303 and 304 in order to reduce the time required in rendering glyphs in the document by utilising multiple computer processing units (CPU). In one arrangement of the present disclosure, each sequence of instructions representing each of the steps 303 and 304 is implemented on separate processing threads associated with different processor cores, being processed concurrently. The method 300 allows querying of the state of transfer of font files over the network 120 in order to allow early processing of the data within a font file before the font file is completely transferred.

The method 500 of transferring font file over the network, as executed at step 303 will now be described with reference to FIG. 5. The method 500 may be implemented as one or more software code modules of the software application program 133 resident on the hard disk drive 110 and being controlled in its execution by the processor 105.

The method 500 begins at font file transferring step 501, by first starting the transfer of the font file over the network 120, under execution of the processor 105. Step 501 includes tasks such as resolving the location of the font file on the network 120, creating communication channels to begin transfer and setting up buffers in memory 106 to store the contents of the font file. An example method of transferring files over networks, which may be used at step 501, includes HyperText Transfer Protocol (HTTP) which is transmitted using the Transmission Control Protocol (TCP) and the Internet Protocol (IP).

Once the transfer is initiated, a block of data is received at receiving step 502 under execution of the processor 105. The received block of data may be stored by the processor 105 in the memory 106. The received block of data may be of arbitrary size and may correspond to the TCP/IP packet size, or may correspond to the size of the receive buffers for storing the data coming from a server providing the font file.

The size of each block of data does not correspond to the structures within the font file and may be configurable for network performance reasons. Once a block of data from the font file is received, a notification of receiving block of data is performed at notifying step 503. Step 503 is configured to allow communication between the two concurrent steps 303 and 304, allowing the file transfer step 303 to notify the rendering step 304 that data is made available in order to evaluate whether rendering is possible. Upon notification that a block of data has been received, at step 503, a measurement of the cumulative amount of data received is determined, and compared to the required amount of data expected for rendering to be possible. As will be described in more detail below, the notification step 503 allows the waiting step 404 of method 400 to continue processing.

Then at evaluating step 504, an evaluation is determined whether all blocks for the font file have been transferred. If the font file has not been completely transferred, then the method 500 continues to step 502, where more blocks of data from the font file are transferred. If the font file has been completely transferred at step 504, then the method 500 concludes and the font file is now completely available at the client.

The notification step 503 in the method 500 allows processing of the font file to occur before the font file has completely transferred at step 505. Prioritising glyphs corresponding to a visible portion of the document within the font file, by arranging the glyphs in the first portion rendering step 304 for the portion of the document corresponding to the visible portion of the document, processing of the font file can be completed before the font file is completely transferred, thereby reducing the delay in displaying the initial view of the document. Furthermore, given that the rest of the font file is also transferred, delays associated with rendering user input and/or further pages of the document are avoided.

The method 400 of rendering the visible portion of the document, as executed at step 304, will now be described in more detail with reference to FIG. 4. The method 400 may be implemented as one or more software code modules of the software application program 133 resident on the hard disk drive 110 and being controlled in its execution by the processor 105.

The method 400 begins at visible portion determining step 401, where the visible portion of the document is determined under execution of the processor 105. Next, the location of the data, within the font file, for the glyphs in the visible portion of the document file is determined at location determining step 402.

Then at evaluating step 403, an evaluation is performed to determine whether the data for the visible glyphs is available. The determination is performed by checking if the amount of data loaded for the font file exceeds that of the highest glyph offset. The highest glyph offset is the location, in the font file, that is sequentially latest amongst the font file locations for the glyphs determined in step 402. If insufficient data is determined to be available at step 403, then the method 400 waits for additional font data to be transferred at waiting step 404. Step 404 waits for a notification to be sent at step 503 in method 500. Once a notification is received from step 503 of the method 500, the method 500 continues to step 403. If the required data is determined to be available at determination step 403, then the method 400 continues to loading step 405.

At step 405, the glyphs appearing in the visible part of the document are loaded from the partially transferred font data. Using the loaded glyphs, the visible portion of the document is rendered at rendering step 406. At step 406 all required glyphs for rendering the visible portion of the document are available and rendering of the glyphs proceeds successfully. Once rendering is complete, the rendered glyphs forming the document are displayed (e.g., on the display 114) at displaying step 407. The method 400 concludes following step 407.

The evaluating step 403 ensures that the required glyphs that are used to render the initial view of the document are available before rendering. As all the available glyphs are made available, the text for the document is subsequently rendered in its intended appearance using the fonts retrieved from the network 120 with reduced delay. Additionally, the process of loading the glyphs at step 405 does not block the process of continued transfer of the font in method 500, as the rendering and file transfer processes may be carried out concurrently and synchronised by communication. The method 400 thereby allows the entire font to be available to the client for further updates to the rendering of the document as additional text is made available.

The fonts that are associated with the document may be specified by storing the location of the font file within the document, as a link or reference to an external resource to be downloaded to the client upon which the document is to be displayed. In documents, such as in HTML, the font may be specified by usage of the “@font-face CSS” at-rule, whereby a URL may be specified indicating a hostname and path of the intended font file that will be served across the HTTP protocol.

When determining the visible portion of the document, at steps 202 and 401, the contents of the document and the dimensions of the viewport for displaying the document are considered. Typically for display devices the viewport for displaying the document is related to the display device itself, whereby characteristics such as the number of pixels of the display, the aspect ratio of the display, and the resolution of the display all affect the viewport. Furthermore, when a display uses re-sizeable controls for displaying content (such as application windows), the amount of displayable content changes.

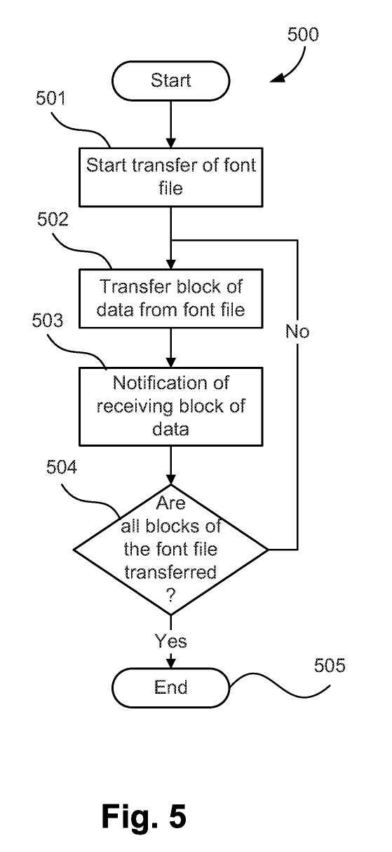

FIGS. 6A and 6B show examples of documents with the same contents displayed using different viewports. Shown in FIG. 6A is an example of a viewport 601 that is typically displayed on a desktop computer. The viewport 601 features a wide aspect ratio (i.e. wider than taller) viewport for displaying documents. As seen in FIG. 6A, document 602 has visible text 603 and may have other visible resources such as an image 606. Outside of the viewport 601, exists further text 604 and images 605 that form the appearance of the document 602 but are not displayable within the viewport 601 at the specified resolution and viewport dimensions.

Shown in FIG. 6B is an example viewport 608 which features a tall aspect ratio (i.e. taller than wide), and is typical of what is available in portable display devices. While the viewport 608 is tall, the viewport 608 may be narrower than viewport 601 or have a different resolution such that each line of text can contain fewer words. Document 609 displayed within the viewport 608 may have a layout beginning with an image first (due to limited horizontal space) which is typical of responsive document layouts. With the smaller viewport 608 and image placement 610 differences in document 609 compared to that in document 602 less visible text 611 is present in FIG. 6B. Due to having less visible text in the viewport 608, there is more non-visible text 612 following the visible text 611, and images 613 are also further away from visible viewport 608 of the document 609.

The amount of visible text therefore is greater for viewports that are larger and visible text is less for viewports that are smaller. A smaller viewport results in fewer glyphs being utilised in the visible portion of the document, thereby reducing the required amount of data that is transferred in order to produce an initial rendering of the document for a smaller viewport display.

In the examples of FIGS. 6A and 6B, an initial view of a document corresponds to the first section of content of that document. However, other arrangements are possible, in which an initial view of a document corresponds to a location part way throughout the content of a document. For example, for a document which is a HTML page, a link may be provided to an anchor tag within a document, with the initial view corresponding to the content location associated with the specified anchor tag.

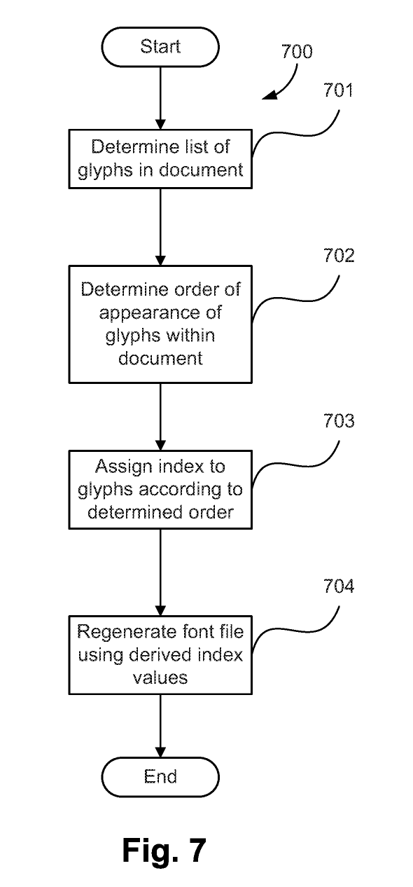

Font files are typically represented by data describing the visual appearance of each character. Furthermore, a lookup mechanism is provided to allow the retrieval of visual appearance data for a given character code point value. FIG. 8 shows an example of a typical font file with minimum information required to store glyph data. Typically, the font file has a section for storing the appearance of glyphs 803, and a lookup table 801 for mapping the character code-points to index values (CMAP) and a table 802 ‘LOCA’ to map the index values to positions within the font. The font file of FIG. 8 is an example of a typical font file format such as TrueType, OpenType and WOFF.

In one arrangement of the present disclosure, the CMAP table 801 and LOCA table 802 are specified before the GLYF table 803 in order to allow determination of the amount of the font file that is loaded before decoding of the glyphs can proceed.

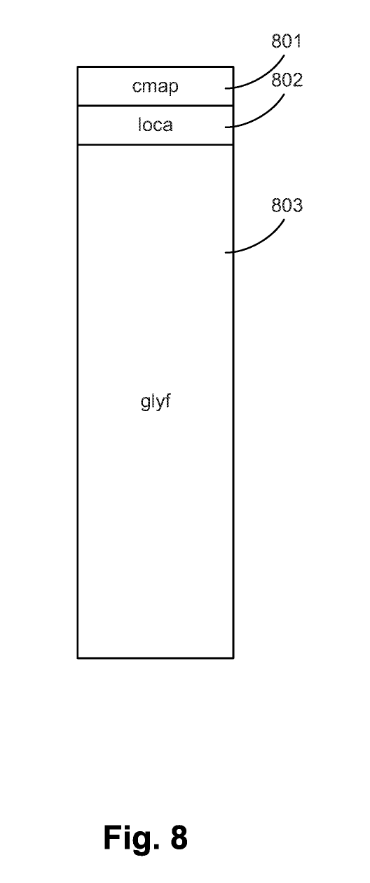

Shown in FIG. 9 is an example font file utilising the arrangement specified in FIG. 8. CMAP table 901 maps code points to index values. For example, character ‘B’ with code-point value sixty-six (66) 902, is associated with index value one (1) 903. In order to determine the location of the shape definition within the font file for the specified character, the index value is used to determine the location within the font file to decode the shape information. Index value ‘1’ 903 for the character ‘B’ has an association 904 to LOCA table 905, whereby the index value 903 in the CMAP 901 table references a corresponding entry index value ‘1’ 906 in LOCA table 905. The entry for index value ‘1’ 906 within the LOCA table 905 maps to offset value of ‘50’ 907, thereby indicating position 910 within GLYF table 912. The size of the required block for storing the shape information for the glyph index value one ‘1’ is determined by evaluating next index value ‘2’ 908, and determining the offset position for index value ‘2’, which for the example of FIG. 9 has an offset value of one-hundred and fifty (150) 909. As such, a download size of the font file may be determined according to a highest glyph offset of the glyphs in the determined list of glyphs. The determined download size may be compared with a current download size of the font file. Offset positions 907 and 909 reference a region 913 within the glyph table 912, which specifies the shape information for the character ‘B’.

Sometimes large fonts may be created with a large number of glyphs. Fonts with a large number of glyphs may be a result of large character sets required for particular languages such as Japanese and Chinese. Fonts may also be large if the fonts support a large number of languages. Fonts may also be large if the fonts contain many character variations as a result of advanced features such as those made available in OpenType's GSUB tables. The large number of glyphs in a font affects the transfer time of fonts and thereby impact on display performance

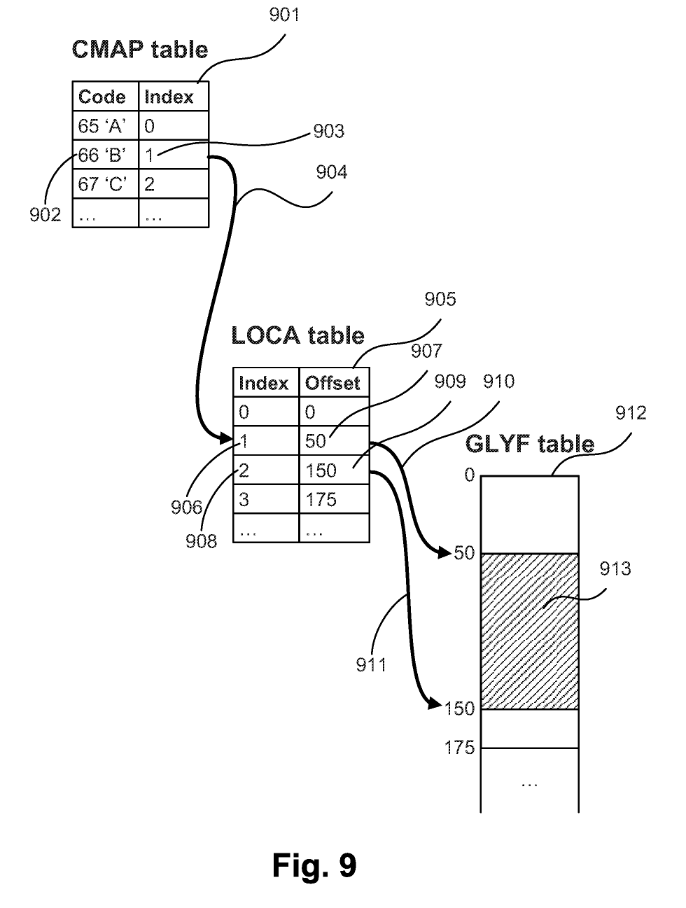

With reference to FIG. 10, performance issues relating to fonts will be described. In the example of FIG. 10, for a particular document to be displayed, and Latin characters ‘A’, ‘B’ and a Chinese character ‘ [symbol] ’ are to be displayed in the document. Unicode codepoints for the Latin and Chinese characters are ‘65’ for ‘A’, ‘66’ for ‘B’ and ‘26085’ for ‘ [symbol] ’. In the example in FIG. 10, entries exist in CMAP table 1001, where character ‘B’ 1002 was assigned index value of ‘1’ 1003 and the character ‘ [symbol] ’ 1004 was assigned index value of ‘1234’ 1005. For index value ‘1’ 1003 in the CMAP table 1001 a corresponding entry in LOCA table 1006 results in an offset value of ‘10’ 1007. Similarly, for index value ‘1234’ 1005 a corresponding entry in the LOCA table 1006 results in an offset value of ‘56789’ 1008. Offset value ‘10’ 1007 from the LOCA table 1006 references block 1010 within GLYF table 1009 and offset value ‘56789’ 1008 from LOCA table 1006 references block 1011 within the GLYF table 1009. As the magnitude of the difference between the offset values ‘56789’ 1008 and 10 1007 is large, then a large block of data 1012 exists between blocks 1010 and 1011. In order to process the character ‘ [symbol] ’, data in block 1012 within the GLYF table 1009, which precedes block 1011, needs to be transferred first. By transferring the block 1012, data that is not needed to render the initial view of the document is transferred, thereby introducing unnecessary delays.

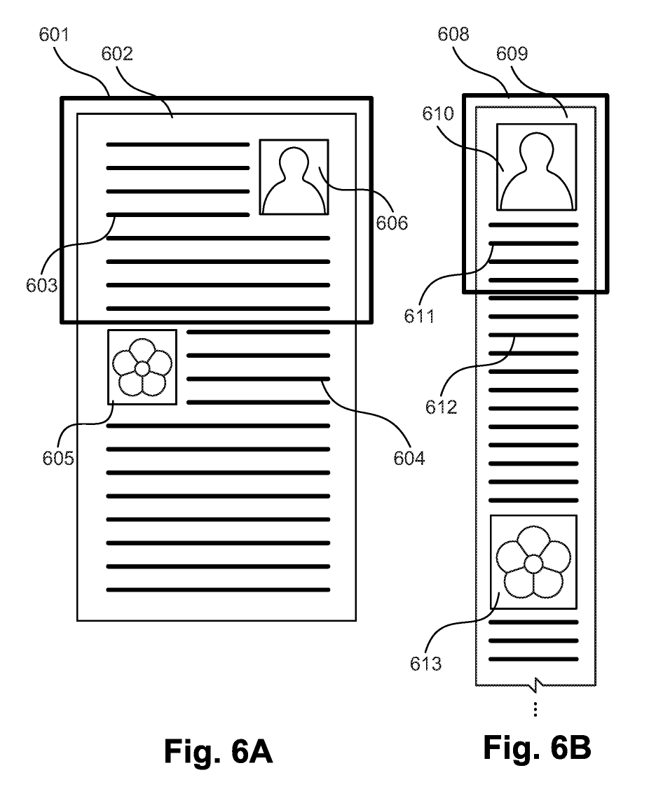

In one arrangement of the present disclosure, a font is utilised that further reduces display time for the initial view of a document. A method 700 of modifying a font file, in accordance with the present disclosure, will now be described with reference to FIG. 7. The method 700 may be implemented as one or more software code modules of the software application program 133 resident on the hard disk drive 110 and being controlled in its execution by the processor 105.

The method 700 begins by determining a list of glyphs within the document, under execution of the processor 105, at list determining step 701. The determining list of glyphs may be stored within the memory 106.

For the glyphs within the document, the order of appearance of glyphs within the document is then determined at order determining step 702. The characters are then assigned index values according to the order of appearance at assigning step 703. Finally, at generating step 704, a font file is generated, under execution of the processor 105, using the index values. The generated font file may be stored in the memory 106. The method 700 then concludes following step 704.

The step of assigning index values to glyphs according to the order of appearance at step 703 proceeds by assigning glyphs that appear earlier in the document with a lower index value. For example, the document may be composed of the word “the” composed of the three characters ‘t’, ‘h’ and ‘e’. Typically, fonts would assign index values for the character ‘t’ with the largest values, and ‘e’ with the smallest values. In one example font, the character ‘e’ has index value ‘72’, character ‘h’ has index value ‘75’ and character ‘t’ has index value ‘87’. If the example document was composed of only the three characters ‘e’, ‘h’ and ‘t’, then only the three characters ‘e’, ‘h’ and ‘t’ are required to correctly display the document initially.

In one arrangement of the present disclosure, an index value of ‘1’ is assigned for ‘t’, an index value of ‘2 is assigned for ‘h’ and an index value of ‘3’ is assigned for ‘e’ thereby ensuring the glyphs are at the beginning of the font file.

In another arrangement, it may not be necessary to have the characters in the exact order of appearance and be sufficient to specify whether the characters are specified in the document or not. The required characters may be stored at the beginning of the font file, and unused glyphs afterwards. Such an arrangement where the characters are not in exact order of appearance, still provides an advantage, as the entire font file does not need to be transferred completely to allow rendering, and a rendering of an initial section of the document can still be performed in without waiting for the entire font resource to be transferred.

In arrangements where an initial view of a document is at a location part way through the content of a document, step 702 for determining an order of appearance of glyphs within the document may consider the order in which glyphs are encountered under both forward and backward navigation throughout the document content. The navigation may originate from the document location specified as the initial view.

In a further arrangement of the present disclosure, an initial document view may contain a navigable link to another location in the same document. In such arrangements, step 702 for determining an order of appearance of glyphs within the document may consider document sections reached by following such navigable links when determining the order of appearance of glyphs within the document. For example, an order of appearance for glyphs in such a document may be generated with glyphs located near the initial view having the earliest appearance, followed by glyphs located near a linked location appearing next, and then followed by all other glyphs used by the document in remaining document locations.

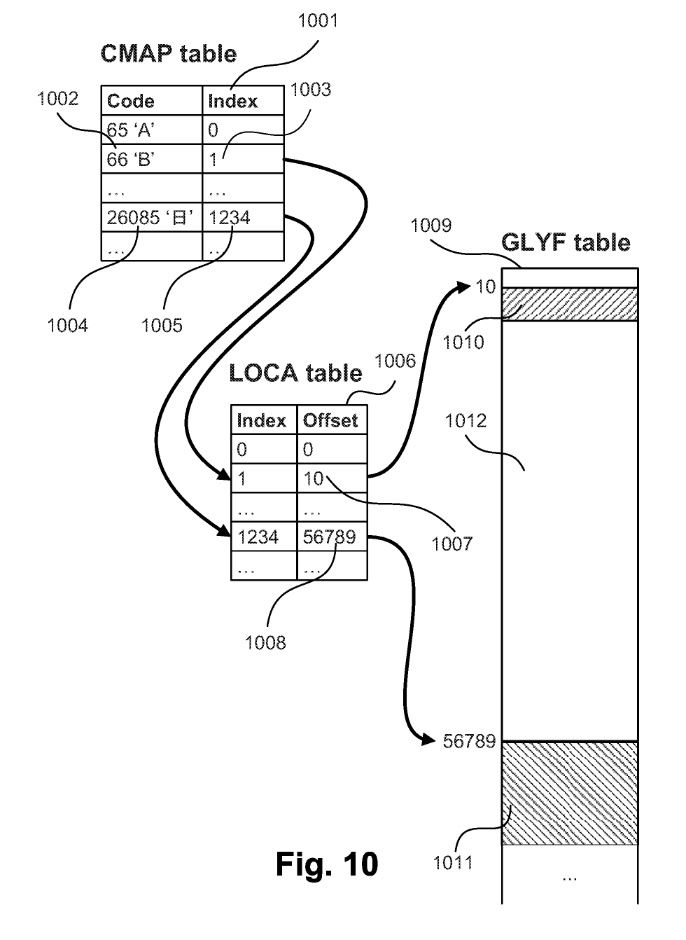

With reference to FIG. 11, the effect of the method 700 is shown when applied to the example font shown in FIG. 10. In the example of FIG. 11, a document to be rendered uses only the two characters ‘A’ and ‘ [symbol] ’. In a font file processed using the method 700, the character ‘A’ 1102 is assigned an index value of ‘0’ 1103 and character ‘ [symbol] ’ 1104 is assigned an index value of ‘1’ 1105. As described at step 703, the index values are assigned values according to the order of appearance in the document. Other glyphs not referenced in the document are then given arbitrary index values following the initially assigned index values for the references glyphs. In the example of FIG. 11, character ‘B’ 1106 is assigned an index value of ‘20’ 1107, which is a larger index value than that of character ‘A’ and character ‘ [symbol] ’ LOCA table 1101 for the example font file of FIG. 11 has reassigned index values according to usage of the glyphs within the document, and the order is affected by the order of appearance in the document. In the CMAP table 1001 for the font, the index values were in ascending order, whereas the index values in the CMAP table 1101 for the font file modified in accordance with the method 700 are no longer ordered.

As the index values in the CMAP table 1101 are modified, the offset values in the LOCA table 1108 are also modified. In the example of FIG. 11, the entry for character ‘z,21 ’ now has index value of ‘1’ 1109 which has an associated offset value of ‘10’ 1110. The shape definition for the characters ‘A’ and ‘ [symbol] ’ correspond to blocks 1112 and 1113 within GLYF 1111, which are now located at the beginning of the table 1111. The glyph entry for character ‘B’ 1106, with index 1107 has an offset value ‘56789’ 1114 which is located away from the beginning of the GLYF table 1111 and therefore will be transferred after the blocks 1112 and 1113 are transferred.

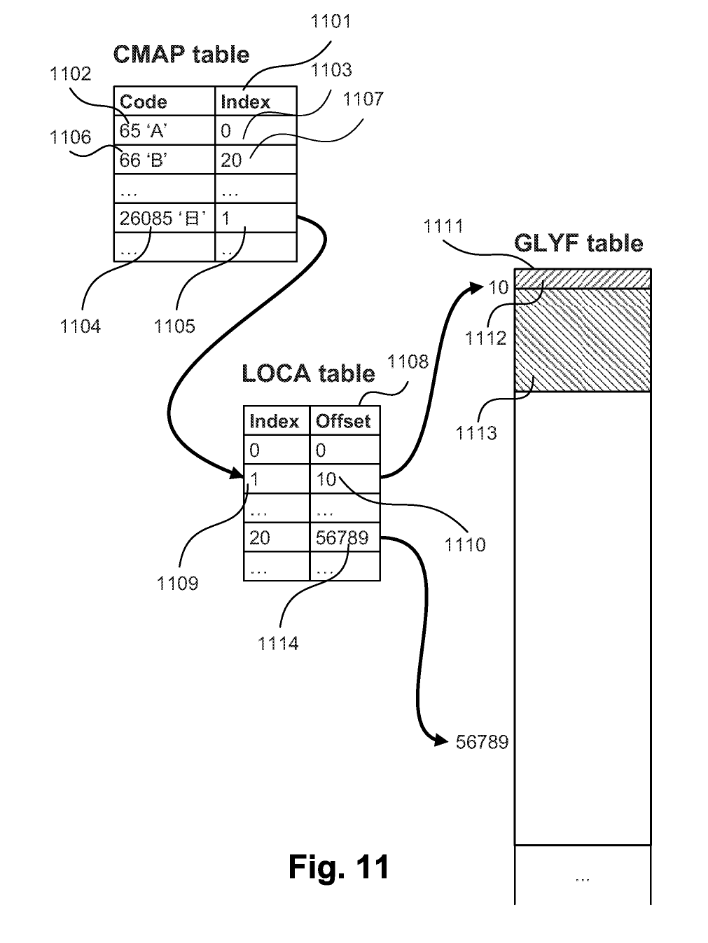

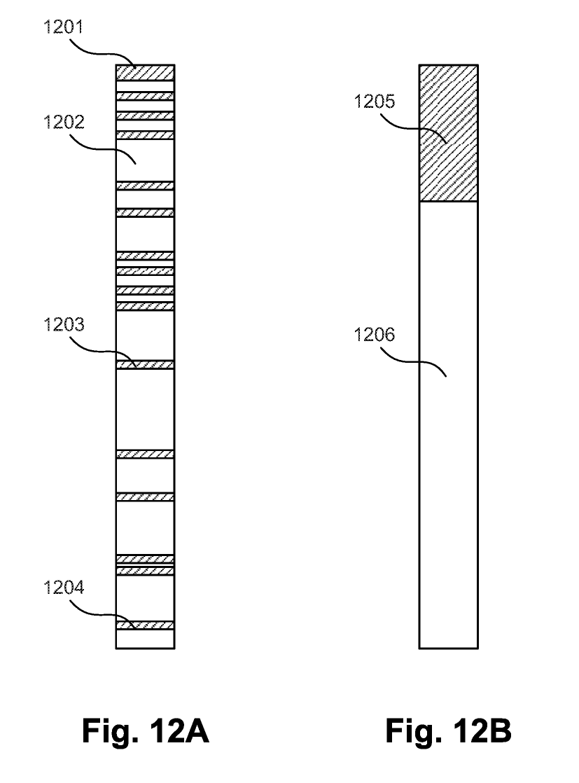

In another example illustrating the effect of method 700, FIG. 12A and FIG. 12B show sections of the font file containing data that is useful for displaying the initial view of a document. FIG. 12A shows an example of a font file before being processed in accordance with the method 700. The font file of FIG. 12A comprises a block 1201 at the beginning of the file, block 1203 at the middle of the file and block 1204 near the end of the file. The blocks 1201, 1203 and 1204 are example blocks of data required for rendering the initial view of the document. As the blocks of data 1201, 1203 and 1204 are scattered throughout the font file, there exists unused blocks such as block 1202 that are transferred despite not contributing to the initial document rendering. As shown in FIG. 12B, after being processed in accordance with the method 700, the required parts of the modified font file are shifted towards the front of the file, such as the block in 1205 and the unused data is in a block 1206 following the used block 1205.

While the data within the modified font files described above have been partitioned into a section which is required for rendering an initial view of document, and remaining not-required section, it is expected that the entire contents of the font file are required for full rendering of the document in the case when user input (e.g., in the form of text entry) is received from a user or retrieval of data from external sources. For example, it is anticipated that a user-interface may be composed of Latin characters, but there may be a requirement that a user has the ability to input their name using characters of a foreign language, such as Japanese. In another example, a document may initially be composed of Latin characters and then the document may later receive external data from a RSS feed, in other languages such as Japanese, for display in the document.

It is therefore advantageous to serve full featured font to allow rendering from all possible characters but without large delays in initial page view which affect the overall user-experience in document viewing.

In some arrangements in accordance with the present disclosure, a document that contains more than one font resource may be handled using similar methods to those described above, where each set of glyphs that appear in the document for each of the font resources is considered separately. For each font, a first portion containing a set of glyphs in that font and corresponding to an initial displayed portion is determined, and encoded into the font resource for that font.

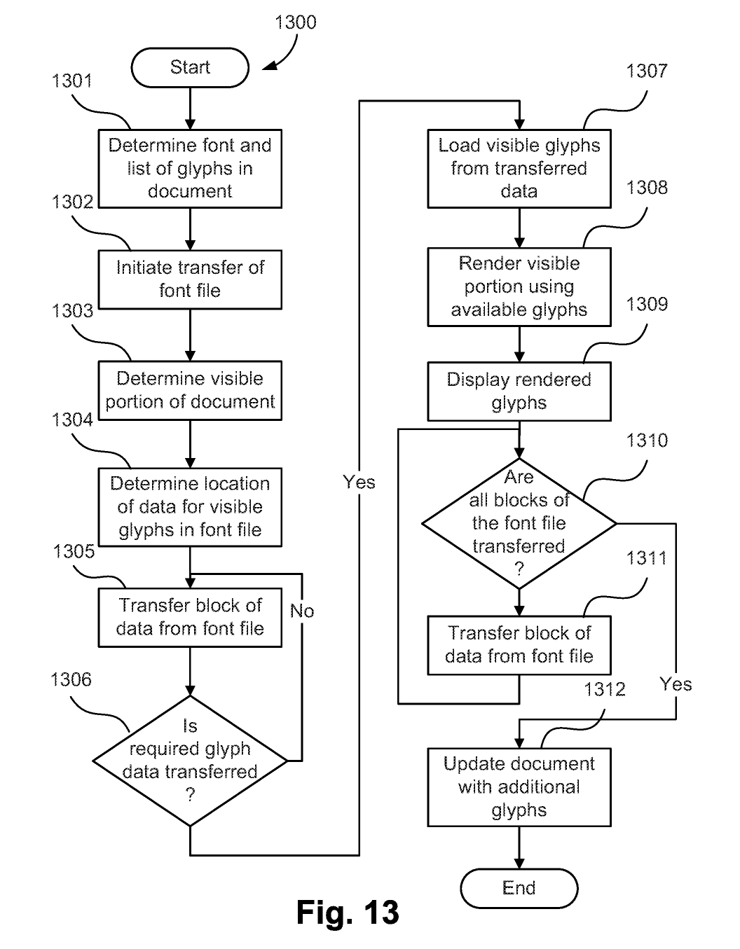

FIG. 13 is a schematic flow diagram illustrating another method 1300 of rendering an electronic document referencing a network transferred font. The method 1300 may be implemented as one or more software code modules of the software application program 133, resident in the hard disk drive 110 and being controlled in its execution by the processor 105.

The method 1300 begins by determining the fonts and list of glyphs used in the document, under execution of the processor 105, at list determining step 1301. The determined list of glyphs may be stored within the memory 106.

The method 1300 then continues to initiating step 1302, where the transfer of the font file from the network 120 is initiated under execution of the processor 105. Then the method 1300 continues by determining the visible portion of the document at visible portion determining step 1303. In determining the visible portion of the document, the set of glyphs included in the visible portion are also determined. The visible portion of the document includes the list of glyphs that are within the visible portion of the document.

Then the location of the required glyph data within the font file is determined at location determining step 1304. Once the required location of the font file is known, the transfer of a block of data from the font file over the network 120 is performed at transferring step 1305. A determination is performed at determining step 1306 to determine whether the data for the required glyphs have been transferred. The steps 1305 and 1306 for transferring a portion of the font file corresponding to the content of a visible portion of the document may also be performed by determining the number of glyphs received, when determining if the required glyph data has been received in decision step 1306, thereby loading only a portion of the font file. The remaining portion of the font file will later be transferred at step 1311.

The determination at step 1306 is performed by using the largest offset value for the visible glyphs, and ensuring that the font file has data transferred at a position exceeding the required largest offset value. If insufficient data has been transferred, then the method 1300 returns to step 1305 where additional blocks of data are transferred again. If it is determined at checking step 1306 that the required data for the glyphs has been transferred, then the method 1300 continues to step loading step 1307.

At step 1307, visible glyph data is loaded, under execution of the processor 105, from the transferred font data. With the glyph shape data for the visible glyphs, the visible portion of the document is rendered at rendering step 1308. The visible portion of the document is displayed to the user at step 1309. For example, the visible portion of the document may be displayed on the display 114.

Then a determination is performed at checking step 1310, to determine if the font file has been completely transferred. If the font file has not been completely transferred, the method 1300 continues to transfer additional blocks of data from the font file at transferring step 1311. Following step 1311, the method 1300 continues back to step 1310. If the font file has been completely transferred at step 1310, then the method 1300 continues to updating the document with the additional glyphs at updating step 1312.

In some arrangements, the described methods may be carried out in a framework for providing web pages from a server to a client device. The framework may include a means of publishing content as web pages that can be transferred for display on the client device over a network. When content is published as web pages, the server also generates font files specifically for displaying fonts on those web pages, and specifically optimised for the actual text content of those web pages. The optimised fonts may then be associated as resources specifically for those published web pages, and may be stored in association with those pages. When a request to view that content is received by the server, the pages may be transferred over the network with those specific font resources so as to provide an optimised web page viewing experience.

### INDUSTRIAL APPLICABILITY

The arrangements described are applicable to the computer and data processing industries and particularly for the processing images.

The foregoing describes only some embodiments of the present invention, and modifications and/or changes can be made thereto without departing from the scope and spirit of the invention, the embodiments being illustrative and not restrictive.

1. A method of displaying an electronic document, the method comprising:
determining a list of glyphs in an electronic document specified with a font, the electronic document being received from a server;
determining that a font file defining the font has been at least partially received by comparing a received portion of the font file with the determined list of glyphs, the font file having the determined list of glyphs stored in a first portion of the font file, a first plurality of the glyphs of the font being arranged at a start of the font file and remaining glyphs of the font being stored in a remaining portion of the font file arranged after the first portion of the font file;
rendering a portion of the electronic document with the first portion of the font file concurrently with receiving the remaining portion of the font file; and
displaying the rendered portion of the electronic document.

2. The method according to claim 1, further comprising:
determining a download size of the font file according to a highest glyph offset of glyphs in the determined list of glyphs; and
comparing the determined download size with a current download size of the font file.

3. The method according to claim 1, wherein the glyphs in the first portion are ordered according to an order of appearance of the glyphs in the electronic document.

4. The method according to claim 1, wherein at least a glyph of the remaining portion of the font file is used to render user input to the electronic document.

5. The method according to claim 1, wherein font information used to render the electronic document is stored in the first portion of the font file and remaining font information is stored in the remaining portion of the font file.

6. The method according to claim 1, wherein the rendered portion of the electronic document is a visible portion of the document displayed to a user.

7. The method according to claim 1, wherein font information used to render the electronic document is stored in the first portion of the font file and remaining font information is stored in the remaining portion of the font file, and the visible portion of the electronic document uses a subset of the first plurality of glyphs.

8. The method according to claim 1, wherein the font file is used to render glyphs in a second electronic document.

9. The method according to claim 1, further comprising storing the location of the font file within the document.

10. The method according to claim 1, further comprising assigning index values to the glyphs according to the order of appearance.

11. The method according to claim 1, further comprising assigning index values to the glyphs according to the order of appearance, and wherein glyphs appearing earlier in the document are assigned a lower index value.

12. The method according to claim 1, wherein the document comprises a plurality of font resources.

13. An apparatus for displaying an electronic document, the apparatus comprising:
means for determining a list of glyphs in an electronic document specified with a font, the electronic document being received from a server;
means for determining that a font file defining the font has been at least partially received by comparing a received portion of the font file with the determined list of glyphs, the font file having the determined list of glyphs stored in a first portion of the font file, a first plurality of the glyphs of the font being arranged at a start of the font file and remaining glyphs of the font being stored in a remaining portion of the font file arranged after the first portion of the font file;
means for rendering a portion of the electronic document with the first portion of the font file concurrently with receiving the remaining portion of the font file; and
means for displaying the rendered portion of the electronic document.

14. A system for displaying an electronic document, the system comprising:
a memory for storing data and a computer program;
a processor coupled to the memory for executing the computer program, the computer program comprising instructions for:
determining a list of glyphs in an electronic document specified with a font, the electronic document being received from a server;
determining that a font file defining the font has been at least partially received by comparing a received portion of the font file with the determined list of glyphs, the font file having the determined list of glyphs stored in a first portion of the font file, a first plurality of the glyphs of the font being arranged at a start of the font file and remaining glyphs of the font being stored in a remaining portion of the font file arranged after the first portion of the font file;
rendering a portion of the electronic document with the first portion of the font file concurrently with receiving the remaining portion of the font file; and
displaying the rendered portion of the electronic document.

15. A non-transitory computer readable medium having a computer program stored thereon for displaying an electronic document, the program comprising:
code for determining a list of glyphs in an electronic document specified with a font, the electronic document being received from a server;
code for determining that a font file defining the font has been at least partially received by comparing a received portion of the font file with the determined list of glyphs, the font file having the determined list of glyphs stored in a first portion of the font file, a first plurality of the glyphs of the font being arranged at a start of the font file and remaining glyphs of the font being stored in a remaining portion of the font file arranged after the first portion of the font file;
code for rendering a portion of the electronic document with the first portion of the font file concurrently with receiving the remaining portion of the font file; and
code for displaying the rendered portion of the electronic document.
